(19) United States
(12) Patent Application Publication
(10) Pub. No.: US 2005/0139054 A1
(43) Pub. Date: Jun. 30, 2005

(54) High flow/high pressure cutting table

(76) Inventor: Ivan Markowitz, Williamsville, NY (US)

Correspondence Address: HODGSON RUSS LLP, ONE M & T PLAZA, SUITE 2000, BUFFALO, NY, 14203-2391, US

(21) Appl. No.: 10/953,128

(22) Filed: Sep. 29, 2004

Related U.S. Application Data
(60) Provisional application No. 60/507,026, filed on Sep. 29, 2003.

(51) Int. Cl. B26D 7/06

(52) U.S. Cl. 83/100; 83/22; 83/24

(57) ABSTRACT

A high flow/high pressure table for supporting and holding sheet material during operations such as cutting which table includes a rigid air plenum structure providing extremely flat surface tolerances for cutting and having high volume cross-flow capability. The plenum structure includes a supporting framework of interlocking strips with air passages therein that determines table strength, flatness and flow capacity. The table configuration includes straight section, large diameter tubes feeding a high pressure/high flow vacuum source. There is also provided zonable low pressure-loss risers for transitioning between tubes and plenum. The plenum structure includes extrusions that provide rigidity for the cutting surface and attachment means for racks and rails to support and guide a gantry assembly associated with the table.

### CROSS REFERENCE TO A RELATED APPLICATION

Applicant claims priority based on U.S. provisional application No. 60/507,026 filed Sep. 29, 2003 and entitled “High Flow/High Pressure Cutting Table”, the disclosure of which is incorporated by reference.

### BACKGROUND OF THE INVENTION

This invention relates to the art of apparatus for performing operations including cutting sheet material such as cloth, and more particularly to a new and improved table for supporting and holding sheet material during such operations.

Vacuum tables have been proposed for supporting and holding down sheet material such as cloth during cutting of the sheet material into desired shapes. Such tables include, briefly, a table top provided with apertures there through, a plenum below the tabletop in communication with the apertures, a vacuum blower and a plumbing system placing the blower in communication with the plenum. In operation, sheet material on the top of the table is held down by the vacuum or suction created by operation of the blower which draws air from the apertures in the table top through the plenum and the plumbing system.

It has been determined according to this invention that certain types of sheet material, such as open woven fabrics, require high flow/high pressure conditions for efficient handling in tables for supporting and holding the sheet material during operations such as cutting.

### SUMMARY OF INVENTION

It is, therefore, an object of this invention to provide a new and improved table for supporting and holding sheet material during operations such as cutting.

It is a more particular object of this invention to provide such a table for efficient handling of open weave fabric and like materials.

It is a further object of this invention to provide such a table with high flow/high pressure operation.

The invention provides a high flow/high pressure table for supporting and holding sheet material during operations such as cutting which table includes a rigid air plenum structure providing extremely flat surface tolerances for cutting and having high volume cross-flow capability. The plenum structure includes a supporting framework of interlocking strips with air passages therein that determines table strength, flatness and flow capacity. The table configuration includes straight section, large diameter tubes feeding a high pressure/high flow vacuum source. There is also provided zonable low pressure-loss risers for transitioning between tubes and plenum. The plenum structure includes extrusions that provide rigidity for the cutting surface and attachment means for racks and rails to support and guide a gantry assembly associated with the table.

The following detailed description of the invention, when read in conjunction with the accompanying drawings wherein the same reference numerals denote the same or similar parts throughout the several views, is in such full, clear, concise and exact terms as to enable any person skilled in the art to which it pertains, or with which it is mostly nearly connected, to make and use the invention. The foregoing and additional advantages and characterizing features of the invention will become clearly apparent upon a reading of the ensuing detailed description together with the included drawings.

### BRIEF DESCRIPTION OF THE DRAWING FIGURES

FIG. 1 is a perspective view of a high flow/high pressure cutting table according to the invention;

FIG. 2 is a developed perspective view of the table of FIG. 1;

FIG. 3 is a developed perspective view of a plenum assembly of the table of FIG. 1;

FIG. 4 is an enlarged, perspective view showing a partially assembled supporting framework for the plenum assembly of FIG. 3;

FIG. 5 is an enlarged, perspective view of a portion of the framework of FIG. 4;

FIG. 6 is an enlarged, perspective view of another portion of the framework of FIG. 4;

FIG. 7 is an enlarged, fragmentary perspective view of one of the strip components of the framework of FIG. 4;

FIG. 8 is a perspective view of a valve assembly of the table of FIG. 1;

FIG. 9 is an enlarged, perspective view showing the arrangement of guide racks and rails for the gantry assembly on the table of FIG. 1;

FIG. 10 is an enlarged, fragmentary perspective view of a portion of the arrangement of FIG. 9;

FIG. 11 is an enlarged, fragmentary perspective view showing the guide racks and rails in FIGS. 9 and 10;

FIGS. 12 and 13 are diagrammatic views further illustrating operation of the high flow/high pressure table according t the invention; and

FIG. 14 is a diagrammatic perspective view of the table of the invention incorporated in a conveyor arrangement.

### DETAILED DESCRIPTION OF THE INVENTION

A basic vacuum table for holding down sheet material during cutting includes an apertured table top, a plenum below the table top in communication with the apertures and a vacuum blower and a plumbing system placing the blower in communication with the plenum. In operation, sheet material on the top of the table is held down by the vacuum or suction created by operation of the blower which draws air from the apertures in the table top through the plenum and the plumbing system.

Certain types of open woven/open cell material require high flow/high pressure conditions for efficient handling in vacuum tables of the foregoing type. In particular, the openings in such open woven/open cell materials define an interstitial or lattice-like structure. A high flow at high pressure is needed from around the solid regions or boundaries outlining the openings and then through the openings to create a force to hold down the material on the surface of the table top.

Some prior art cutting tables have structures supporting the cutting surface which would cause pressure loss under high flow conditions. For example, table plenums have been created using honeycomb materials sandwiched between two surfaces. This provides desired flatness and rigidity but severely limits high cross-flow. Some arrangements have opened air paths provided by holes drilled in the honeycomb permitting some amount of cross-flow, but this still is very limited. Other prior art cutting tables have plumbing components that create pressure drops in high flow or long length configurations. In particular, all known prior cutting tables which employ pipes or tubes in the plumbing system do not have high flow capacity. Any known prior tables having high flow capacity are based on large vacuum chambers.

Accordingly it is an object of this invention to provide a flat/rigid table surface for performing operations such as cutting on various materials in sheet form while at the same time eliminating pressure loss in the structure supporting the cutting surface under high flow conditions needed for operations on open woven/open cell materials. It is a further object to eliminate plumbing components that create pressure drops in high flow or long length table configurations. It is an additional object to give the table the capability to provide vacuum zones for optimizing material-holding pressure. It also is an object to provide convenient and easy attachment of guide racks and rails to the table structure.

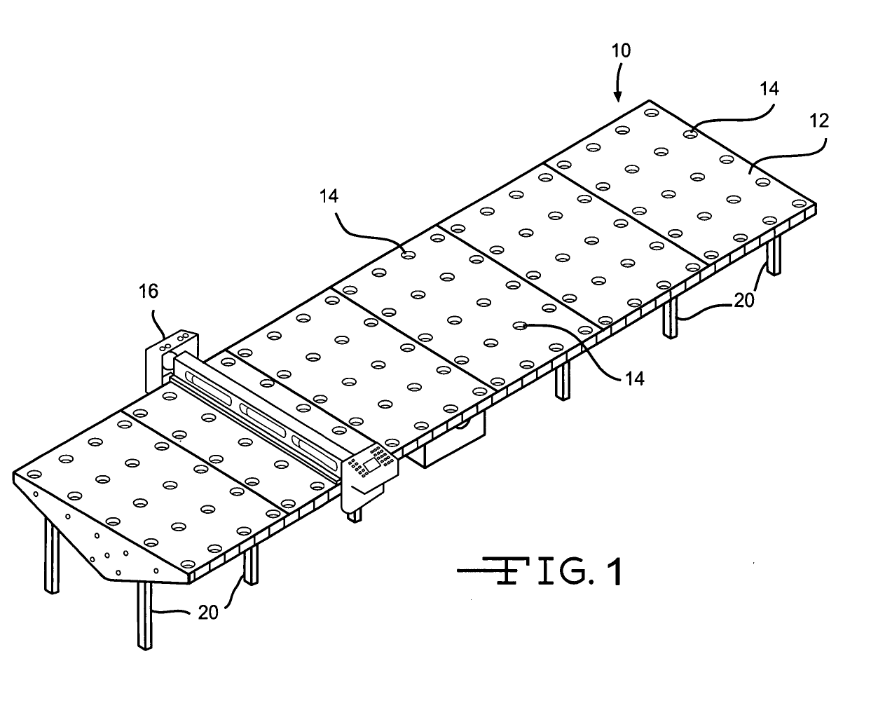

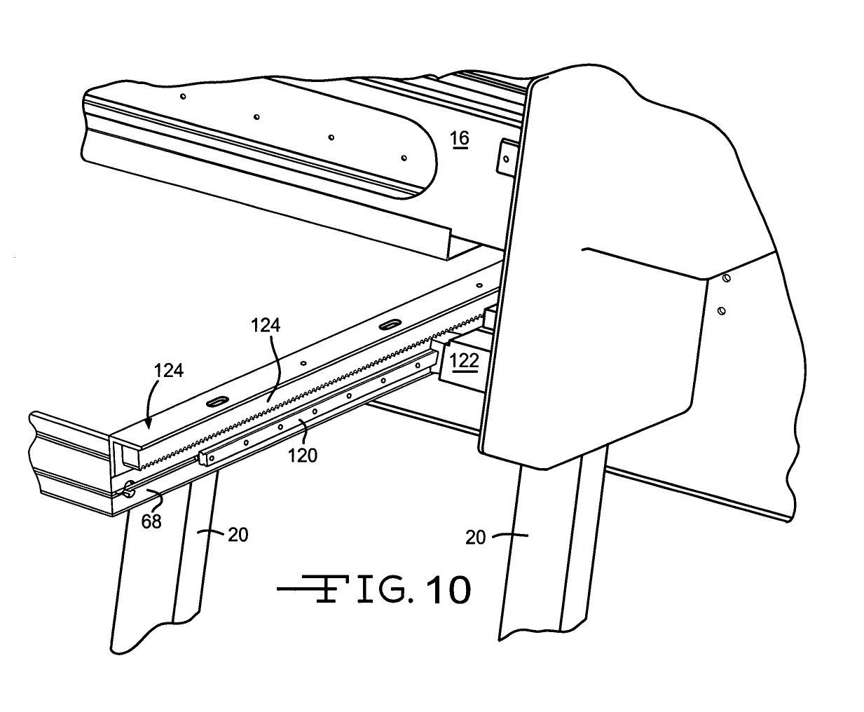

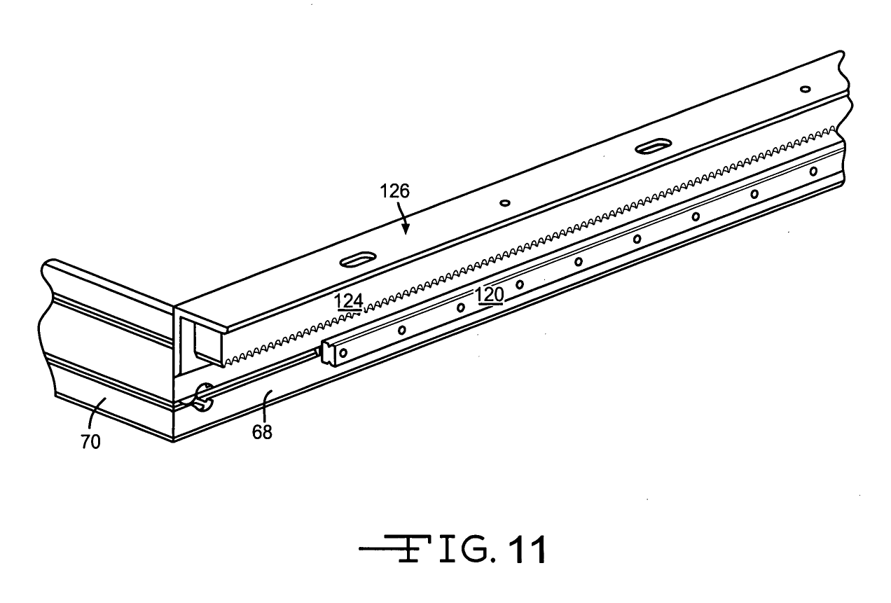

A high flow/high pressure cutting table according to the present invention is shown in FIGS. 1-11. It has a rigid air plenum structure providing extremely flat surface tolerances for cutting. It includes an air plenum structure with high volume cross-flow capability. The plenum structure includes a supporting framework of interlocking strips that determines table strength, flatness and flow capacity. The table configuration includes straight section, large diameter tubes feeding a high pressure/high flow vacuum source. There is also provided zonable low pressure-loss risers for transitioning between tubes and plenum. The plenum structure includes extrusions that provide rigidity for the cutting surface and attachment means for racks and rails to support and guide a gantry assembly associated with the table.

Referring to FIG. 1, the table 10 according to the invention includes an air-permeable top surface 12 which in the present illustration is divided into a plurality of sections extending lengthwise along the table. Preferably a plurality of apertures 14 are provided in surface 12 for communication with a plenum (not show in FIG. 1) located beneath the surface. The particular number of apertures 14 shown in FIG. 1 is for convenience in illustration, a greater number of apertures per unit of table surface area being provided in an actual table. By way of example, in an illustrative table, apertures 14 comprise 0.026 inch diameter holes arrayed in a 0.25 inch by 0.25 inch pattern. Illustrative materials for an apertured supporting surface 12 include polyurethane surface belting material or thin plastic sheet material such as Lexan. Alternatively, a non-apertured material with sufficient porosity to provide a vacuum-creating air flow can be employed, such as the porous material commercially available under the designation POREX. In any event, surface 12 must allow sufficient air flow therethrough while at the same time providing a solid surface on which the sheet material can be cut.

A gantry 16 carrying tooling for operating on sheet material, such as a cutter for operating on cloth, is supported by and movable along table 10 in a known manner. Table 10 is supported by a series of vertical legs 20 which rest on a floor or other supporting surface.

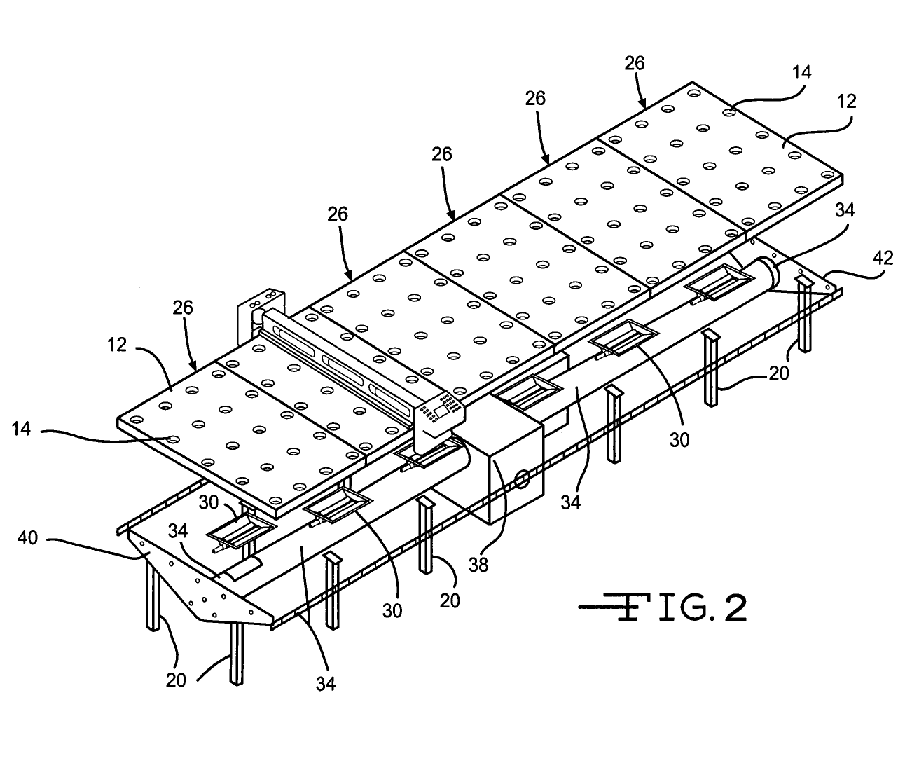

The developed view of FIG. 2 shows a series of plenum assemblies 26 located beneath each section of the table top surface 12. A corresponding series of valved riser assemblies 30, one for each plenum assembly, is provided for placing each plenum in controlled fluid communication with a pipe or conduit 34 which, in turn, is converted to a blower unit 38. A pair of end panels 40 and 42 close off the ends of pipe 34 as well as supporting the same, the panels 40, 42 being joined to pairs of the table legs 20.

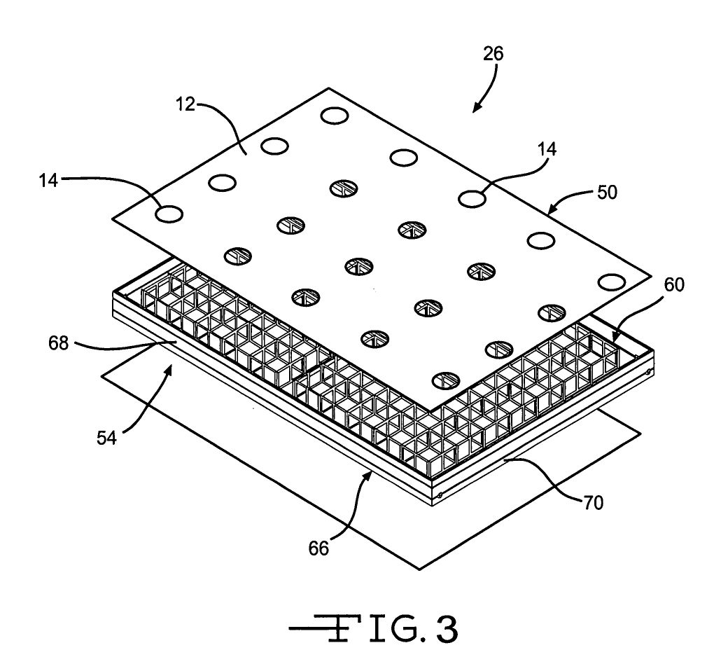

One of the plenum assemblies 26 is shown in detail in FIG. 3. The plenum top surface is defined by a rigid sheet 50, preferably of metal, which is provided with a series of apertures 51. The particular number of apertures 51 is shown in FIG. 3 for convenience in illustration. In an actual plenum, a greater number of apertures per unit of table surface area typically is provided, for example apertures of about 0.25 inch diameter closely spaced to allow a substantial flow of air therethrough. Furthermore, various patterns of apertures can be employed. The plenum assembly 26 also includes a base 54 in the form of a rigid sheet, preferably of metal, of substantially the same shape and dimensions of top sheet 50 and preferably of substantially the same thickness. Base 54 is solid with the exception of a central opening (not shown) for connection to a corresponding one of the valved riser assemblies 30 in a manner which will be described. In the completed plenum assembly 26, top sheet 50 and base 54 are disposed in spaced apart substantially parallel planes.

The plenum assembly 26 further includes a supporting framework 60 between top sheet 50 and base 54. Supporting framework 60 comprises a grid-like arrangement of orthogonally disposed strips each having a series of openings along the length thereof as will be described in further detail presently. The supporting framework 60 is located within a peripheral frame 66 having substantially parallel side members 68 joined to substantially parallel end members 70. Frame 66 is of rigid material such as metal or plastic and preferably is extruded.

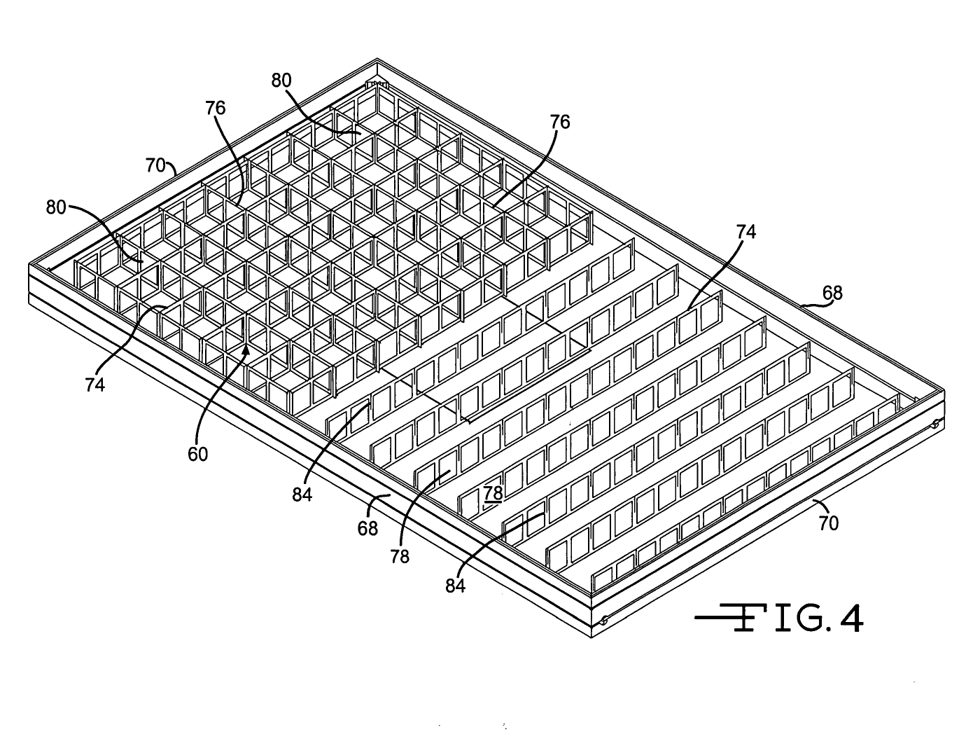

The plenum assembly 26 is illustrated in further detail by the partially-completed assembly shown in FIG. 4. The upper half as viewed in FIG. 4 is a completed framework comprising spaced-apart laterally-extending strips 74 which are interconnected with spaced-apart longitudinally extending strips 76 in an orthogonal arrangement. Strips 74 and 76 are stamped or otherwise formed from thin sheet material such as metal or plastic. In the framework illustrated in FIGS. 3 and 4, the longitudinal and lateral spacings between strips are substantially equal thereby defining substantially square-shaped open regions between adjacent strips. Each of the strips has a series of closely spaced openings or windows along the length thereof, i.e. the openings 78 in the laterally extending strips 74 and the openings 80 in the longitudinally extending strips 76. The opposite ends of each of the laterally extending strips 74 abut the frame members 68, and the opposite ends of each of the longitudinally extending strips 76 abut the frame members 70 in a completed plenum assembly. The laterally extending strips 74 and longitudinally extending strips 76 are interconnected by means of co-operating slits or notches in each of the strips. In the lower half of the assembly as viewed in FIG. 4, where only the laterally extending strips are shown, the slits or notches 84 in those strips can be seen. In particular, slits 84 are provided at equally-spaced intervals along the length of each strip, the spacing determining the distance between the longitudinally extending strips. In the arrangement shown, the slits 84 extend from the upper edge of each strip 74 as viewed in FIG. 4 to a point about halfway down the width of the strip. Co-operating slits are provided in the longitudinally extending strips to provide an interlocked arrangement in a manner which will be described. The completed framework of longitudinally and laterally extending strips may be viewed as an egg carton-like assembly.

By virtue of the many openings or windows in the laterally and longitudinally extending strips and the open regions defined by the intersections of the strips, there is provided an air plenum structure with high volume, cross-flow capability. The supporting framework of interlocking strips provides table strength and flatness together with flow capacity. The rigid air plenum structure 26 provides extremely flat surface tolerances for cutting.

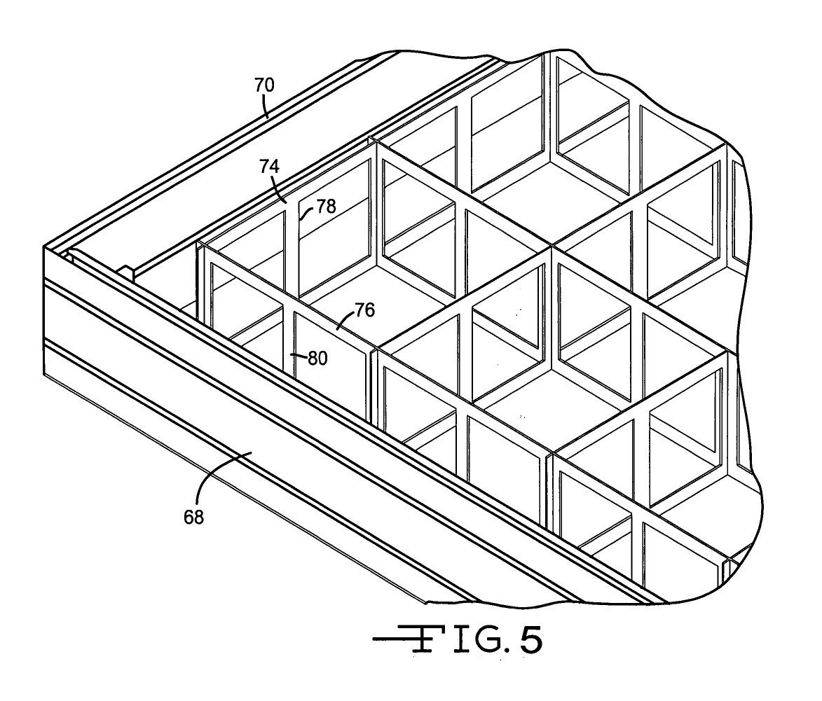

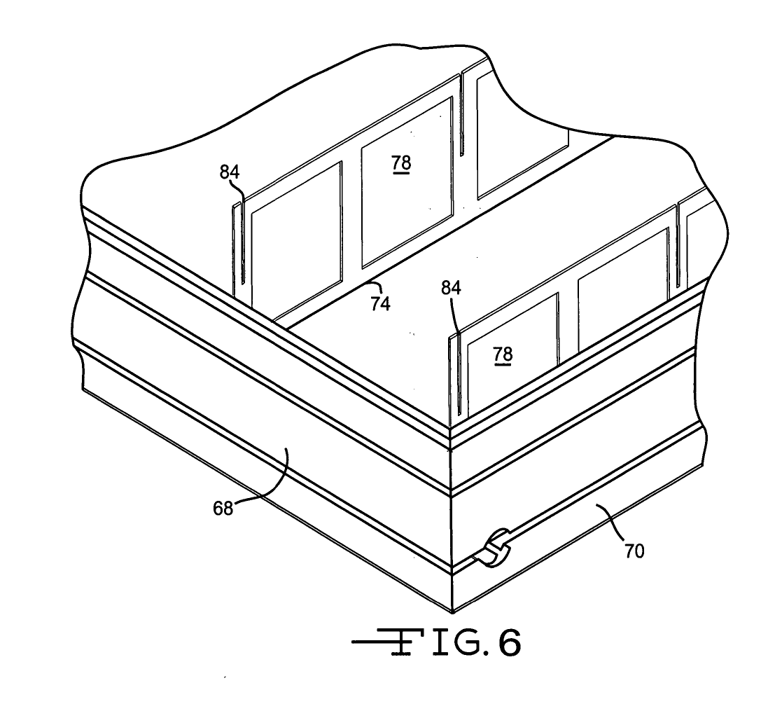

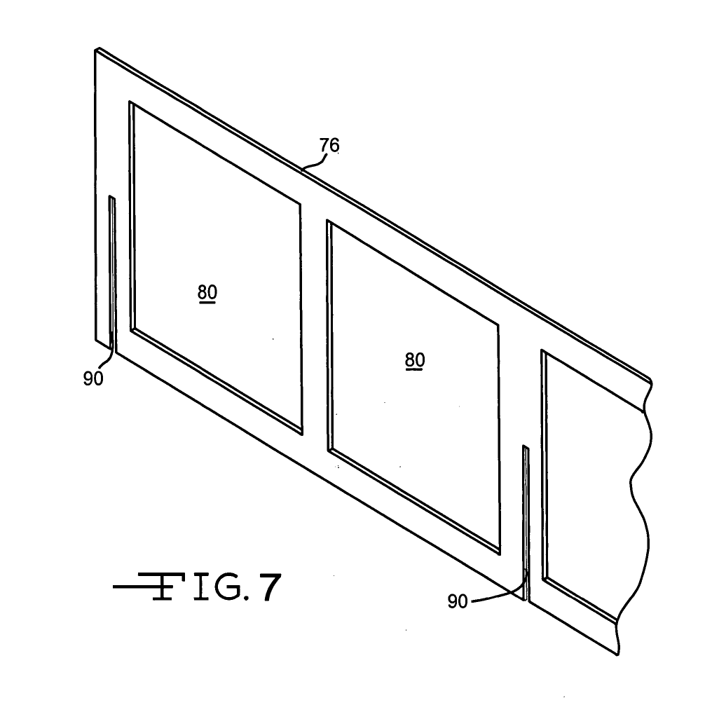

FIG. 5 is an enlarged view of the upper left-hand corner of the assembly of FIG. 4 and shows in further detail the structure of the interlocking lateral 74 and longitudinal 76 strips. FIG. 6 is an enlarged view of the lower left-hand corner of the assembly of FIG. 4 and shows in further detail the laterally-extending strips 74 including the openings 78 and slits 84 therein. FIG. 7 shows in detail one of the longitudinally extending strips 76 including the openings 80 and slits 90 therein. The slits 90 are provided at equally spaced intervals along the length of each strip. In the arrangement shown, the slits 90 extend from the bottom edge of each strip 76 as viewed in FIG. 7 to a point about halfway up the width of the strip. The spacings between slits 90 in strips 76 are equal to the spacings between slits 84 in strips 74 so as to provide the square-shaped open regions between adjacent strips previously described. In assembling the framework, the slits 90 of a longitudinally extending strip 76 are aligned with the series of slits 84 of the plurality of laterally extending strips 74 and then the strip 76 is fitted onto the plurality of strips 74 to provide an interlocked assembly. This is repeated for each of the longitudinally extending strips 76. This procedure could be done after the laterally extending strips 74 are located within frame 66, or the framework of strips 74 and 76 could be assembled first and then placed in frame 66 thereafter.

By way of example, in an illustrate table, each plenum assembly has a width, measured longitudinally of table 10, of about 48 inches and a height of about 3 inches. The plenum length, measured laterally of table 10, is determined by the width of the sheet material being cut or otherwise operated on. A typical plenum length is about 86 inches. Each of the windows or openings 78 and 80 in strips 74 and 76, respectively, has a size of about 2.5 inches by 2.5 inches. The windows or openings are spaced along the corresponding strips in an arrangement of two windows or openings every 6 inches. Strips 74 are spaced 6 inches from each other and, likewise, strips 76 are spaced 6 inches from each other.

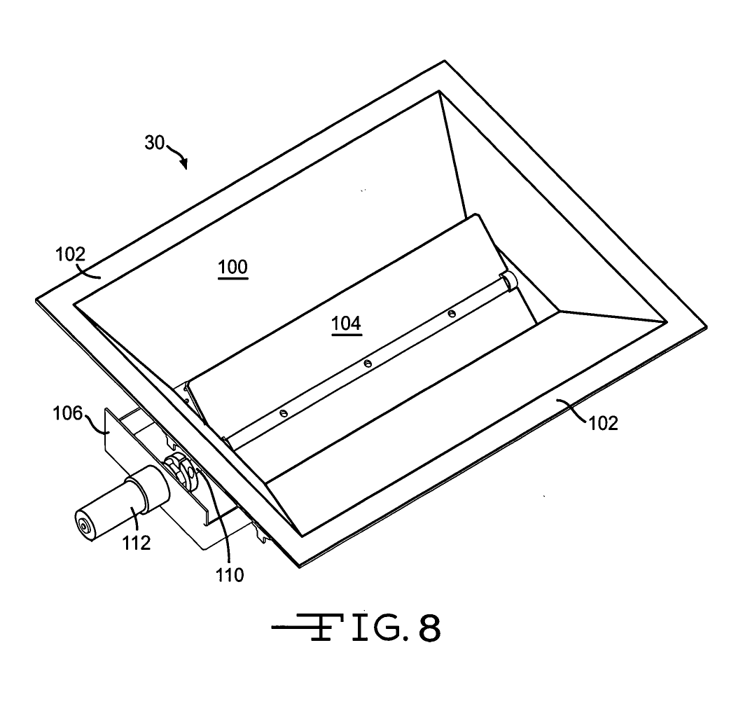

The plenum assembly 26 shown in FIGS. 3-7 is one of a plurality of such assemblies included in the table of the invention. Six such plenum assemblies 26 are shown in the illustrative table 10 of FIG. 1, but the actual number will vary depending on the length of a particular table. Each plenum assembly 26 is placed individually in controlled fluid communication with pipe 34, and thus ultimately with blower unit 38, by a corresponding valved riser assembly 30. One such assembly is illustrated in FIG. 8. It includes a housing 100 having a peripheral lip 102 which is attached to the base 54 of the corresponding plenum assembly 26 for placing the interior of the plenum assembly in fluid communication with the interior of the riser housing 100. A movable valve element 104 controls fluid communication between the interior of riser housing 100 and a duct-like structure 106 leading from riser housing 100 to an opening in pipe 34. The valve element 104 is of the butterfly type, being fixed to a shaft 110 operated by a controlled valve motor 112. By virtue of the provision of a plurality of plenum assemblies 26 and corresponding valved riser assemblies 30, table 10 is given the capability to provide vacuum zones for optimizing material-holding capability. All or some of the plenum assemblies 20 can be placed in fluid communication with pipe 34 and blower unit 38 by selective operation of the valved riser assemblies 30. The combination of plenum assemblies 26, valved riser assemblies 30, pipe 34 and blower unit 38 eliminates the prior art plumbing components that created pressure drops in high flow or long length table configurations. By way of example, in an illustrative table, blower 38 can be a 7.5 HP blower. The foregoing illustrative table can operate, for example, at a maximum flow from the pump at 3000 cfm and at a maximum pressure of 18 inches of water.

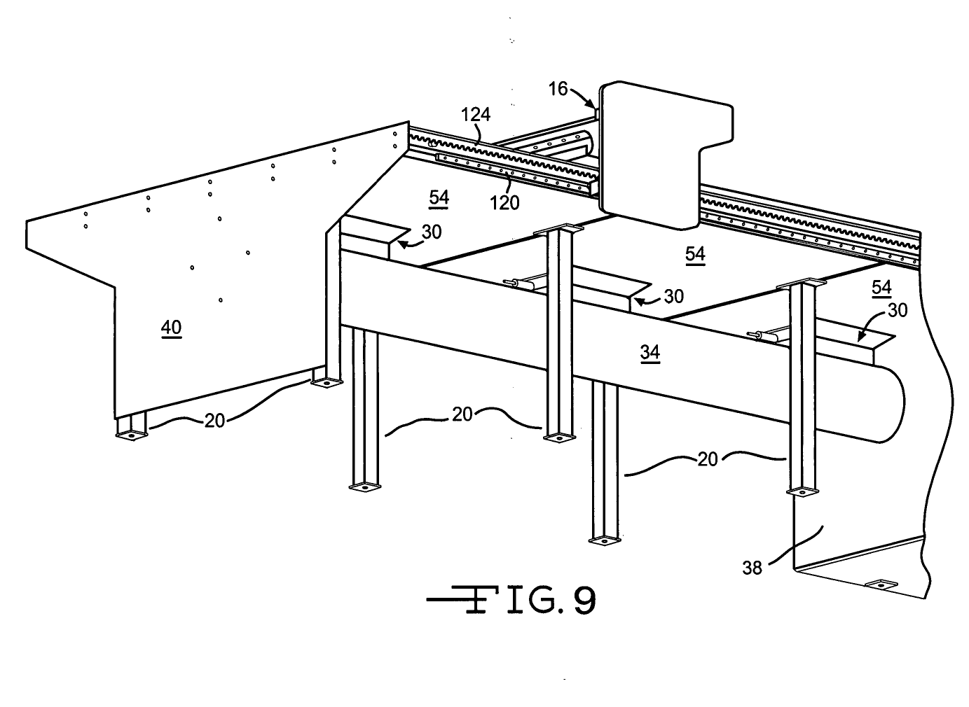

FIGS. 9-11 show in further detail the arrangement for guiding movement of gantry 16 along table 10. Gantry 16 carries an appropriate tool for operations on the sheet material, such as a cutter, router, drill, marker or the like. As gantry 16 moves longitudinally along table 10, the tool is moved along gantry 16 and thus laterally of table 10. Such operation is well-known to those skilled in the art. Gantry 16 is provided with a linear bearing 120 or the like which co-operates with a guide rail 122 which extends along the side of table 10 and is attached to the series of plenum assembly frame members 68 located along the length of table 10. Gantry 16 is moved along table 10 by engagement between a motor driven gear (not shown) on gantry 16 and a rack 124 which extends along table 10 in spaced relation to guide rail 122. Rack 124 is attached to one flange of an angle member 126, the other flange of which is attached to the series of plenum assembly frame members 68 along the length of table 10. The arrangement of plenum assembly frame members along the length of table 10 provides a convenient and easy attachment of guide racks and rails to the table structure.

In the operation of table 10, a sheet of material on which operations such as cutting are to be performed is placed on the table top overlaying the top surfaces 12 of the plenum structures 26. Operation of blower 38 draws air through the sheet material, apertures 14, the plenum framework 60, risers 30 and through pipe 34 to blower 38. The high flow at high pressure from around the solid regions or boundaries outlining the openings in the sheet material and then through these openings onto surface 12 and through apertures 14 creates a force to hold down the sheet material on the table top. Gantry 16 can move along the table and the tool carried thereby can operate effectively on the sheet material. The supporting framework 60 of the plenum structures 26 provides table strength and flatness while at the same time having high volume, cross-flow capability. The risers 30 and pipe 34 avoid the losses associated with prior art plumbing arrangements characterized by small passages or openings leading from plenums.

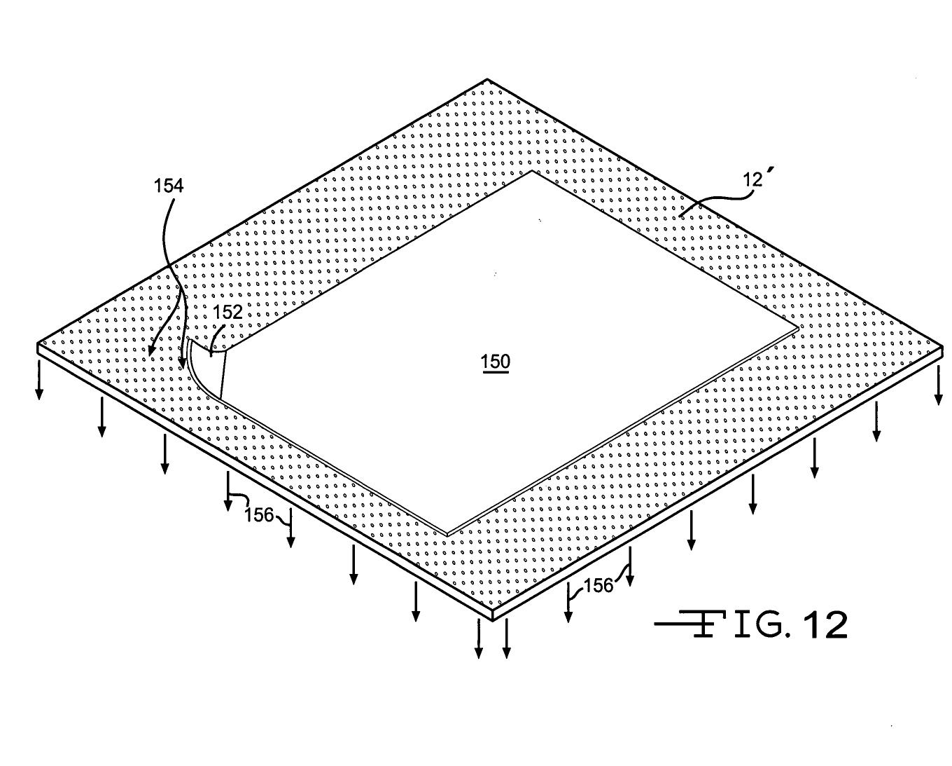

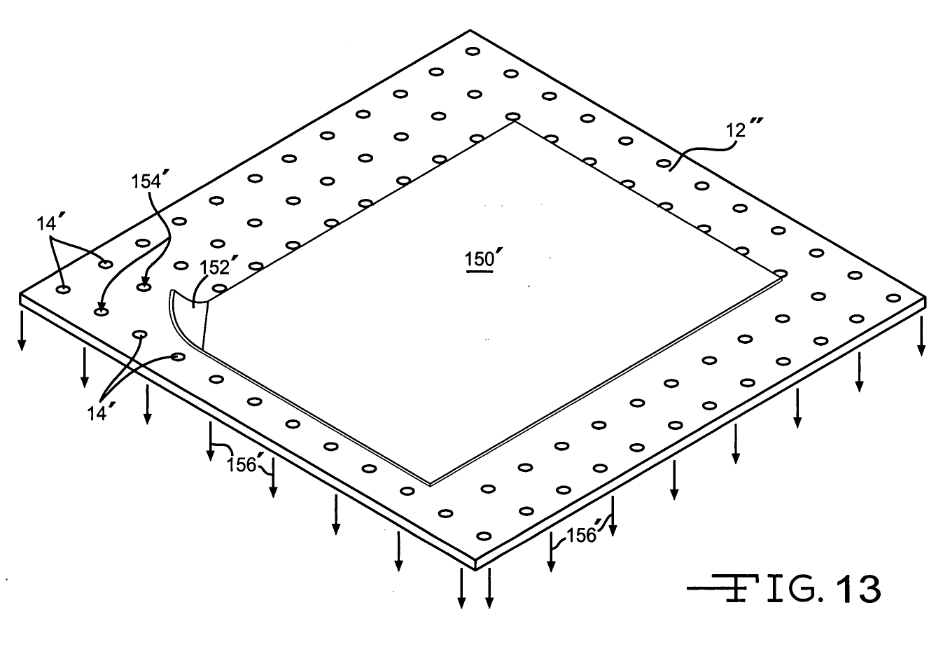

It has been determined that not only does the high flow help hold down open/porous materials, but it also provides additional hold-down on the edge of all materials being cut. When cutting, if the cutting blade causes the edge of the material to move or lift, the accuracy will be impacted. In tables heretofore available, the vacuum pressure on the entire table has very little effect on the edge if the edge is lifted, since atmospheric pressure is present at the cutting location. However, if there is a significant air flow velocity under the edge being cut, this velocity will create additional pressure to hold the material edge in place. The foregoing is illustrated in FIG. 12 which shows sheet material 150 being cut and resting on the air permeable supporting surface 12′. A corner 152 of the material is lifted for purposes of illustration. The high velocity air flow under the sheet material is represented by arrows 154, and the high flow through the surface 12′ is represented by the arrows 156. This velocity can also be amplified by utilizing a cutting surface on the table which consists of a solid material with small holes drilled in it. The smaller the diameter of the holes, the greater the velocity. The foregoing is illustrated in FIG. 13 wherein components similar to those shown in FIG. 13 are designated by the same reference numerals, with a prime or double prime indication and wherein the holes or apertures are designated 14′.

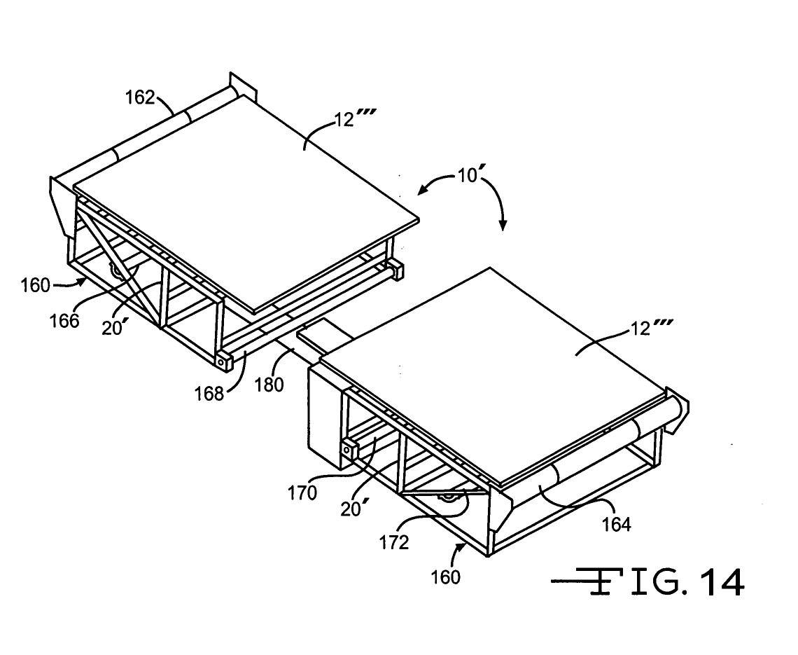

FIG. 14 shows a table 10′ according to the present invention provided with a conveyor for moving the sheet material along the top surface 12′″. One of the plenum assemblies has been removed for purposes of illustration. The previously described table legs 20′ are part of a frame structure generally designated 160. The conveyor arrangement can include a pair of end rollers 162, 164 at opposite ends of the table and rotatably supported in frame 160. A series of additional conveyor rollers 166, 168, 170 and 172 can be provided beneath the series of plenums and rotatably supported in frame 160. The conveyor belt, a portion of which is shown at 180, is of suitable air-permeable material, and extends around all the rollers and along the top surface 12′″ beneath the sheet material for conveying the material along surface 12′″. A suitable conveyor drive arrangement (not shown) would be provided. For a more detailed description of an exemplary conveyor for use in vacuum-hold down apparatus for cutting sheet material, reference may be made to U.S. Pat. No. 6,520,057 issued Feb. 18, 2003 and entitled “Continuous System And Method For Cutting Sheet Material”, the disclosure of which is incorporated by reference.

If desired, an overlay of suitable thin sheet material can be placed over the sheet material being cut or otherwise operated on. Such an overlay controls the flow to direct and distribute the air flow across the apertured table top surface. The air permeability of the overlay is the control parameter. The table of the invention is usable with various open weave materials and open cell materials such as open woven cloth and fabric, woven fiberglass, open cell foam material, etc. A variety of tools can be used for operation on the sheet material, such as knives, routers and drills to mention a few. On extremely long tables, the valves in selected risers can be operated to close and shut off sections of the table not in use.

It is therefore apparent that the invention accomplishes its intended objectives. While an embodiment of the invention has been described in detail, that has been done for the purpose of illustration, not limitation.

1. A high flow/high pressure apparatus for holding and supporting open woven/open cell sheet material during operations such as cutting comprising:
a) at least one plenum structure having an air permeable member defining a supporting surface for the sheet material, an enclosed interior region and a supporting grid arrangement in the interior region to provide strength, rigidity and flatness for the air permeable member and high volume, high pressure flow in the interior region; and
b) means for placing the interior region of the plenum structure in fluid communication with a blower to draw air through the air permeable member and through the plenum interior region to hold the sheet material on the supporting surface.

2. Apparatus according to claim 1, wherein the means for placing the interior region of the plenum structure in fluid communication with the blower includes a valve.

3. Apparatus according to claim 2, wherein the apparatus includes a plurality of plenum structures and associated valves arranged in a series lengthwise along the apparatus and further including a conduit for connecting the blower to each of the valves.

4. Apparatus according to claim 3, wherein each of the valves is provided with a motor for operating the valve so that selected ones of the plenum structures can be placed in operation.

5. Apparatus according to claim 1, wherein the plenum structure is generally rectangular in shape and wherein the grid structure comprises spaced-apart laterally extending strips interconnected with spaced-apart longitudinally extending strips, each of the strips having a series of openings spaced along the length thereof.

6. Apparatus according to claim 5, wherein the laterally extending strips and the longitudinally extending strips are interconnected by co-operating notches in each of the strips.

7. Apparatus according to claim 1, wherein the air permeable member comprises a sheet of rigid material having apertures therethrough.

8. Apparatus according to claim 1, wherein the enclosed interior region of the plenum structure is defined by an air impermeable member spaced from the air permeable member and a peripheral frame between the two members supporting the members and enclosing the space therebetween.

9. Apparatus according to claim 8, wherein the plenum structure is generally rectangular in shape and wherein the peripheral frame is generally rectangular in shape and having a section thereof extending lengthwise of the apparatus, the section having mounted thereon:
a) a guide rail for co-operating with a linear bearing on a gantry to guide the gantry during movement along the apparatus for performing operations on the sheet material; and
b) a rack for engagement with a driven gear on the gantry to move the gantry along the apparatus for performing operations on the sheet material.

10. Apparatus according to claim 1, further including a conveyor for moving the sheet material along the supporting surface.

11. In a vacuum hold-down apparatus for supporting and holding sheet material such as cloth during operations such as cutting and including an air permeable supporting surface on which the sheet material is placed and a source of vacuum in communication with an improved plenum associated with the supporting surface, the plenum comprising:
a) a first rigid sheet of air permeable material defining the supporting surface of the table;
b) a second rigid sheet of air impervious material spaced from the first sheet;
c) a peripheral frame between the first and second sheets and enclosing an interior region therebetween; and
d) a grid structure between the first and second sheets for providing support between the first and second sheets and for providing air flow paths in two angularly disposed directions along the interior region.

12. Apparatus according to claim 11, wherein the grid structure comprises a first series of spaced-apart strips each having openings spaced therealong and a second series of spaced-apart strips each having openings spaced therealong, the first and second series of strips being disposed at angles to each other.

13. Apparatus according to claim 11, wherein the grid structure comprises spaced-apart laterally extending strips interconnected with spaced-apart longitudinally extending strips, each of the strips having a series of openings spaced along the length thereof.

14. Apparatus according to claim 13, wherein the laterally extending strips and the longitudinally extending strips are interconnected by co-operating notches in each of the strips.

15. Apparatus according to claim 10, wherein the first sheet is provided with a plurality of apertures therethrough.

16. Apparatus according to claim 11, wherein the second sheet is provided with an opening therein for connection to a valve assembly.

17. Apparatus according to claim 16, wherein the valve assembly controls communication between the interior region of the plenum assembly and the source of vacuum.

18. Apparatus according to claim 16, wherein a motor is provided in the valve assembly for selective operation of the valve assembly.

19. Apparatus according to claim 10, wherein the plenum structure is generally rectangular in shape and wherein the peripheral frame is generally rectangular in shape and having a section thereof extending lengthwise of the apparatus, the section having mounted thereon:
a) a guide rail for co-operating with a linear bearing on a gantry to guide the gantry during movement along the apparatus for performing operations on the sheet material; and
b) a rack for engagement with driven gear on the gantry to move the gantry along the apparatus for performing operations on the sheet material.

20. A method for holding and supporting open woven/open cell sheet material during operations such as cutting, the material having openings defining an interstitial/lattice-like structure with solid boundaries outlining openings in the material, the method comprising:
a) providing a plenum structure having an air permeable supporting surface for the sheet material, an enclosed interior region and a supporting grid arrangement in the interior region to provide strength, rigidity and flatness for the supporting surface and allowing high volume, high pressure flow in the interior region;
b) placing the interior region of the plenum structure in fluid communication with a blower; and
c) operating the blower to draw air through the air permeable supporting surface and through the plenum interior region to hold the sheet material on the supporting surface;
d) said step of operating the blower to draw air including providing a flow of air at high velocity and high pressure around the solid boundary regions outlining the openings in the sheet material and through the openings to create a force to hold down the sheet material on the supporting surface;
e) said step of operating the blower to draw air including providing high volume, high pressure flow through the interior region of the plenum structure.
